(19) United States
(12) Patent Application Publication
(10) Pub. No.: US 2026/0094854 A1
(43) Pub. Date: Apr. 2, 2026

(54) COMPRESSION DEVICE FOR FUEL CELL STACKS

(71) Applicant: BALLARD POWER SYSTEMS INC., Burnaby (CA)

(72) Inventors: Ian Muller STEWART, Vancouver (CA); Kirk John DANIELLS, Burnaby (CA); Rachel Hanna MAY, Squamish (CA); Parvez Singh GREWAL, Surrey (CA)

(21) Appl. No.: 19/111,964

(22) PCT Filed: Sep. 13, 2023
(86) PCT No.: PCT/US2023/032594

§ 371 Date: Mar. 14, 2025

Related U.S. Application Data
(60) Provisional application No. 63/406,620, filed on Sep. 14, 2022.

(51) Int. Cl. H01M 8/248

(52) U.S. Cl. CPC H01M 8/248

(57) ABSTRACT

A fuel cell stack comprising a compression plate assembly comprising a second end plate having a first planar surface and an opposing second planar surface, wherein the first planar surface is adjacent a fuel cell stack and the second planar surface is adjacent a compression housing, wherein the compression housing comprises: a spring recess and a plurality of discrete grooves on its inner axial surface of the spring recess; a spring assembly in the spring recess; a load disc in the spring recess and in contact with the spring assembly; and a resilient retaining apparatus in the spring recess and in contact with the load disc; wherein the resilient retaining apparatus engages with one of the plurality of discrete grooves and the load disc and the spring assembly are physically separated from the inner axial surface of the spring recess.

### BACKGROUND

### Technical Field

The present invention relates to fuel cell stacks, and more specifically, to compression devices for fuel cell stacks.

### Description of the Related Art

Fuel cells are devices in which fuel and oxidant fluids electrochemically react to generate electricity. One type of fuel cell being developed for various commercial applications is the solid polymer electrolyte fuel cell, which employs a membrane electrode assembly (MEA) comprising a solid polymer electrolyte made of a suitable ionomer material (e.g., Nafion®) disposed between two electrodes. Each electrode includes an appropriate catalyst located next to the solid polymer electrolyte. The catalyst may be, for example, a precious metal, non-precious metal, or an alloy or intermetallic compound thereof, which may optionally be supported on a suitable catalyst support, such as carbon, graphite, or metal oxide. The catalyst may be disposed in a catalyst layer. The catalyst layer usually contains a binder and/or ionomer, which may or may not be the same as that used for the solid polymer electrolyte. A fluid diffusion layer (a porous, electrically conductive sheet material) is typically employed adjacent to the electrode for purposes of mechanical support, current collection, and/or reactant distribution. In the case of gaseous reactants, such a fluid diffusion layer is referred to as a gas diffusion layer. If a catalyst layer is incorporated onto a gas diffusion layer, the unit is referred to as a gas diffusion electrode.

For commercial applications, a plurality of fuel cells are generally stacked in series in order to deliver a greater output voltage. Separator plates are typically employed adjacent the gas diffusion electrodes in solid polymer electrolyte fuel cells to separate one cell from another in a stack. Separator plates are usually bipolar with anode flow field passages on one side for supplying fuel to the MEA and cathode flow field passages on the other for supplying oxidant to the MEA. Coolant flow field passages are formed between the anode flow field passages side and the cathode flow field passages side. In this situation, two flow field plates are usually glued together, each flow field plate having either anode flow field passages or cathode flow field passages on one side and coolant flow field passages on the other that are glued together such that the coolant flow field passages side faces each other. Fluid distribution features, including inlet and outlet ports, fluid distribution plenums and numerous fluid channels, are typically formed in the surface of the separator plates adjacent the electrodes to distribute reactant fluids to, and remove reaction by-products from, the MEA. Separator plates also provide a path for electrical and thermal conduction, as well as mechanical support and dimensional stability to the MEA. Exemplary materials used for separator plates include metal, carbon and expanded graphite.

Typical fuel cell stacks further include supply manifolds for directing the fuel and the oxidant to the anode and cathode flow field passages respectively. Fuel cell stacks also usually include a supply manifold for directing a coolant fluid to interior passages of the separator plates within the fuel cell stack to absorb heat generated by the exothermic reaction in the fuel cells. Fuel cell stacks also generally include exhaust manifolds for removing unreacted fuel and oxidant gases, as well as an exhaust manifold for the coolant stream exiting the fuel cell stack.

Fuel cell stacks are usually compressed to ensure adequate electrical contact. Conventional methods of compressing fuel cell stacks typically utilize springs, hydraulic or pneumatic pistons, pressure pads or other resilient compressive means that cooperate with end plates and tie rods, which are generally substantially rigid, to urge the two end plates towards each other to compress the fuel cell stack. However, tie rods typically add significantly to the weight of the stack and are difficult to accommodate without increasing the stack volume. Furthermore, the associated fasteners add to the number of different parts required to assemble a fuel cell stack.

Fuel cell stack compression is made more complicated by fuel cell stack thickness changes over time due to material creep and thermal expansion/contraction of the various fuel cell components as well as variations in fluid pressure during operation. In one fuel cell stack compression assembly design described in U.S. Pat. No. 6,057,053, a compression assembly comprises a compression mechanism and a restraining mechanism. The compression mechanism urges the first end plate towards the second end plate applying an internal compressive force to the fuel cell assemblies, even as the thickness of the fuel cell assemblies change. The restraining mechanism prevents movement of the first end plate away from the second end plate by preventing deflection of the compression mechanism, which may occur, for example, when internal fluid pressure is increased. In one embodiment, a compression mechanism comprises a plurality of stacked disc springs and the restraining mechanism comprises a rigid load ring which circumscribes the stacked disc springs. The disc springs are interposed between one of the end plates and a load disc held in place by a stack retention device such as a bolted tie rod or retention band. The load ring has a threaded inner circumferential surface which cooperates with a threaded outer circumferential surface of the load disc. Rotation of the load ring moves it toward the adjacent end plate. The rotation of the load ring may be done manually, for example, at periodically scheduled maintenance checks or automatically, using an apparatus for continuously applying a rotary force to the load ring to prevent any gap from forming between the load ring and the load plate. When the first end plate moves towards the second end plate, the restraining mechanism adjusts in coordination with movement of the first end plate to maintain contact between the load ring and the first end plate. However, vibration of the stack during operation may lead to undesirable rotation of the threaded load ring, thereby loosening the disc springs and reducing stack compression pressure. Additionally, threads on the load ring and load disc are prone to galling and corrosion, thus making it difficult to take apart the compression assembly when necessary, for example, to replace faulty fuel cells and/or plates. Furthermore, holes for the tie rods going through the fuel cell stack may require additional sealing elements, which further complicates the design of the fuel cell stack.

While many designs for stack compression assemblies have been suggested, there remains a need for further improvement in the design of stack compression assemblies for fuel cell stacks.

### BRIEF SUMMARY

In one embodiment, a fuel cell stack comprises a first end plate, a compression plate assembly, a plurality of fuel cells interposed between the first end plate and the compression plate assembly, and a restraining mechanism for substantially preventing movement of the first end plate from the compression plate assembly, wherein the compression plate assembly comprises: a second end plate having a first planar surface and an opposing second planar surface, wherein the first planar surface is adjacent the fuel cell stack; a compression housing adjacent the opposing second planar surface of the second end plate, wherein the compression housing comprises: a spring recess comprising a plurality of discrete grooves on its inner axial surface; a spring assembly in the spring recess and in contact with the second planar surface of the second end plate; a load disc in the spring recess and in contact with the spring assembly; and a resilient retaining apparatus in the spring recess and in contact with the load disc; wherein the resilient retaining apparatus engages with one of the plurality of discrete grooves and the load disc; and the load disc and the spring assembly are physically separated from the inner axial surface of the spring recess.

In further embodiments, the resilient retaining apparatus comprises a first resilient retaining ring that engages with one of the plurality of grooves and an outer circumferential area of the load disc.

In yet further embodiments, the resilient retaining apparatus further comprises a second resilient retaining ring that engages with an adjacent one of the plurality of grooves, wherein the first and second resilient retaining rings are separated by a spacer and whereby at least some compressive force is transmitted from the first retaining ring to the second retaining ring through the spacer.

In further embodiments, the fuel cell stack further comprises a plurality of planar sides that are removably attached to the first end plate and the compression housing.

In another embodiment, a method of assembling the fuel cell stack is provided. The method comprises the steps of providing the spring assembly into the spring recess; providing the load disc into the spring recess on top of the spring assembly so that the load disc is in contact therewith; compressing the load disc in an axial direction relative to the spring recess so that an axial compressive force is exerted on the spring assembly; compressing a resilient retaining apparatus in a radial direction and providing the compressed resilient retaining apparatus on top of the load disc; and releasing the compressed resilient retaining apparatus so that the resilient retaining apparatus engages with one of the plurality of discrete grooves and the load disc.

These and other aspects of the invention will be evident in view of the attached figures and the following detailed description.

### BRIEF DESCRIPTION OF THE DRAWINGS

FIG. 1 shows an exploded view of an exemplary fuel cell stack according to one embodiment.

FIG. 2 shows an exploded sectional view of the compression assembly according to one embodiment.

FIG. 3 shows a sectional view of the compression assembly in an assembled state.

FIG. 4 shows an exemplary retaining ring according to the present description.

FIG. 5 shows a sectional view of a situation in which the retaining ring tilts in the spring recess.

FIG. 6 shows a sectional view of another embodiment in which a second resilient retaining ring and a spacer are used in the compression assembly.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as “comprises” and “comprising” are to be construed in an open, inclusive sense, that is, as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

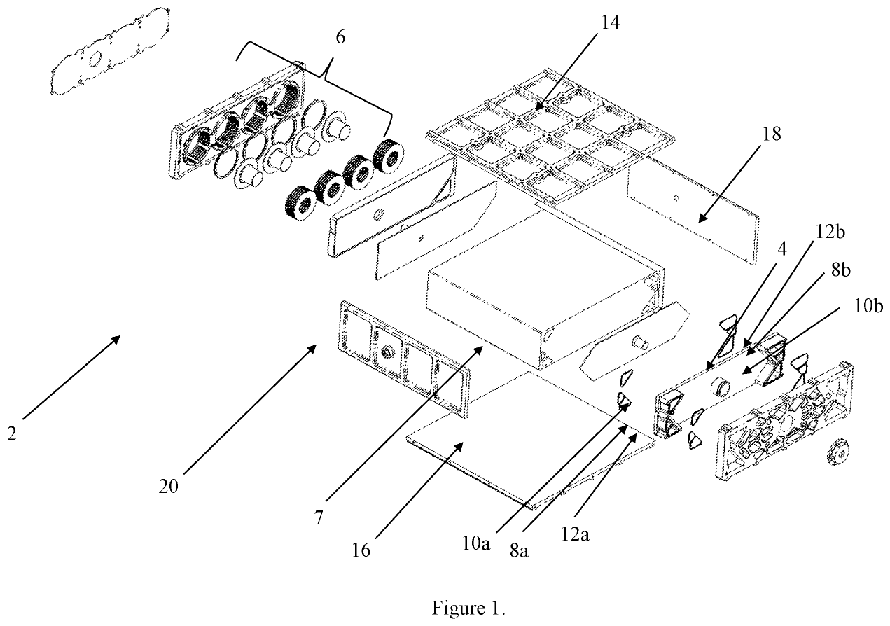

FIG. 1 shows an exploded view of an exemplary fuel cell stack according to one embodiment of the present description. Fuel cell stack 2 includes a first end plate 4, a compression assembly 6, and plurality of fuel cells 7 compressed between first end plate 4 and compression assembly 6. First end plate includes manifolds 8a, 8b, 10a, 10b, 12a, 12b for each of the fuel, oxidant and coolant inlets and outlets so that fuel, oxidant and coolant can be directed into and out of fuel cell stack 2. Fuel cell stack 2 further includes a restraining mechanism in the form of an enclosure having sides 14, 16, 18, 20 that engages with first end plate 4 and compression assembly 6. In an assembled configuration, the enclosure substantially prevents the movement of first end plate 4 from compression assembly 6 so that fuel cell stack 2 can maintain a fixed length. One skilled in the art will appreciate that a fixed fuel cell stack length is desirable for integration in fuel cell systems.

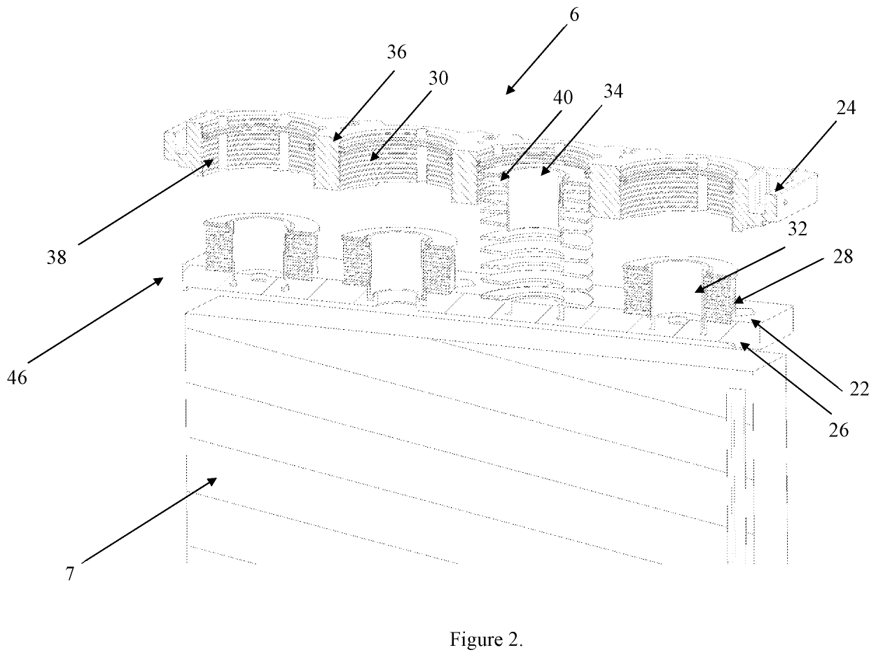

FIG. 2 shows an exploded sectional view of compression assembly 6 according to one embodiment. Compression assembly 6 includes a second end plate 22 and a compression housing 24. Second end plate 22 has a first planar surface 26 that is adjacent fuel cells 7 and an opposing second planar surface 28 that is adjacent compression housing 24. Compression housing 24 includes four spring recesses 30, each recess containing a spring assembly 32 in contact with second planar surface 28, a load disc 34 in contact with spring assembly 32, and a retaining ring 36 in contact with load disc 34. Spring recess 30 has a series of discrete grooves 38 that circumscribe its inner axial surface. Load disc 34 also includes an axial collar 40 for keeping spring assembly 32 substantially aligned. In the case of stacked disc springs, axial collar 40 extends through the discs to keep them substantially aligned during assembly, and also prevent misalignment of the disc springs and contact with the discrete grooves and the inner axial surface of the spring recess over time. Collar 40 need not be in contact with spring assembly 32 but may be in contact with at least a portion of the spring assembly if the spring assembly 32 comes out of alignment. One skilled in the art will be able to size collar 40 according to the disc spring dimensions and related tolerances. One skilled in the art will appreciate that FIG. 2 is meant to show the spring assembly, load disc and retaining ring in various assembled and unassembled states in each of the spring recesses for understanding purposes.

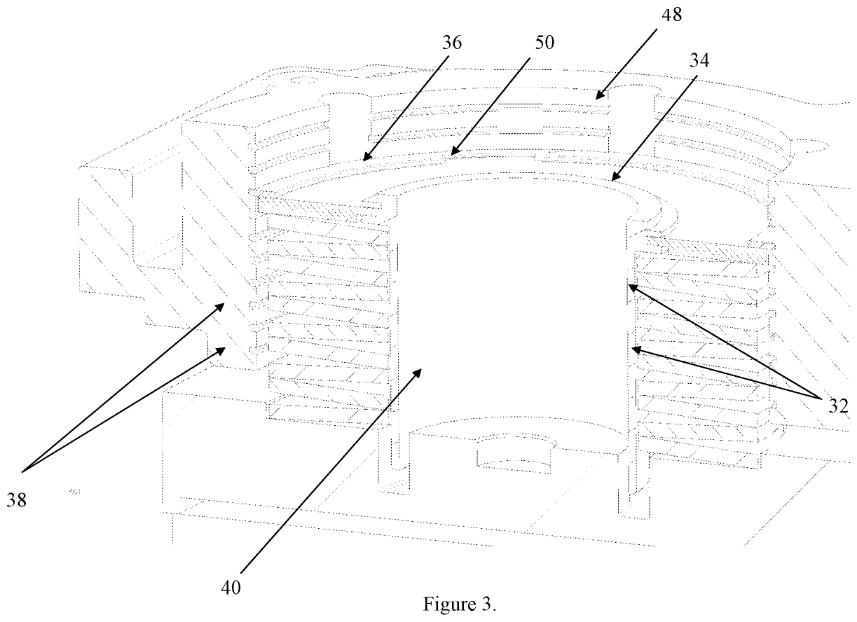

FIG. 3 shows a sectional view of a simplified compression assembly 6 in an assembled state. The outer circumferential area of retaining ring 36 engages with one of discrete grooves 38 while the inner circumferential area of retaining ring 36 engages with the outer circumferential area of load disc 34. In this manner, retaining ring 36 provides a compressive force to load disc 34, as well as to spring assembly 32 (only one spring disc is shown for simplification). While the restraining mechanism substantially prevents movement of the first end plate from the compression assembly and maintains a fixed fuel cell stack length, spring assembly 32 may compress and expand as necessary, thereby providing a continuous axial compressive force to the fuel cells 7 (not shown) even when there is a reduction or expansion in fuel cell thickness due to, for example, changes in operating pressure, thermal expansion and/or fuel cell material creep. As a result, the axial compression pressure exerted on the fuel cells is not negatively impacted during operation and over time.

Retaining ring 36 is preferably resilient so that it can elastically deform in the radial direction during assembly of the compression assembly but still stiff in the axial direction of the compression assembly so that it can apply a compressive force on load disc 34. Additionally, each groove 38 on the axial surface of spring recess 30 is preferably discrete, for example, each groove is not connected with any other groove. This is in contrast with threads because threads are continuous and connected in a spiral or helical configuration. As mentioned in the foregoing, one disadvantage of using threaded designs is that it is difficult to take apart the compression assembly if there is corrosion and/or galling in the threads.

To assemble the compression assembly, a spring assembly 32 is placed in spring recess 30 and then a load disc 34 is placed on top of spring assembly 32. Preferably, spring assembly 32 and load disc 34 are made smaller than spring recess 30 (e.g., in the case of a round spring recess, the spring assembly 32 and load disc 34 are made smaller in diameter than the diameter of spring recess 30) so that it is easier to place spring assembly 32 and load disc 34 into spring recess 30. An axial compression force is then applied to load disc 34 to the desired compression load. Once the desired compression load is achieved, retaining ring 36 is elastically compressed in the radial direction to fit into spring recess 30, placed on top of load disc 34, and then released so that the outer circumferential area of retaining ring 36 engages with one of discrete grooves 38 to hold retaining ring 36 in place, thereby applying an axial compressive force to load disc 34, which in turn compresses spring assembly 32 and fuel cells 7. Preferably, there are a plurality of discrete grooves 38 so that the compression load exerted on the fuel cells can be easily adjusted by engaging resilient retaining ring 36 with different discrete grooves to achieve the desired range of compression load on fuel cells 7. Retaining ring 36 can also be easily removed and adjusted to engage with a different discrete groove if there is a decrease in the fuel cell stack compression load over time, or even replaced if there are issues related to corrosion and/or galling of the retaining ring, for example. In some embodiments, a load cell may be utilized in the compression assembly during assembly to ensure that the desired compression load is applied and/or to monitor the fuel cell stack compression load over time. One skilled in the art will appreciate that the more and the thinner the discrete grooves (and, therefore, the thinner the resilient retaining ring that engages with the discrete grooves), the greater the compression load resolution when adjusting the compression load on the fuel cell stack.

In another embodiment, spring recess 30 may include load grooves 48 on its axial surface that run parallel to the axial direction relative to spring recess 30 (i.e., in a generally perpendicular direction relative to discreet grooves 38) to allow for easier placement of the resilient retaining ring into one of the discrete grooves. In this example of assembling the compression plate assembly, a device having a plurality of mechanical fingers holds the resilient retaining ring and load disc while also compressing the resilient retaining ring in the radial direction in one step. The load grooves allow the mechanical fingers to slide into the spring recess and load the resilient retaining ring and load disc into the spring recess and on top of the spring assembly. Once the desired compression load is achieved, the mechanical fingers release the resilient retaining ring and then slide out of the spring recess via the load grooves. The release of the mechanical fingers allows the resilient retaining ring to engage with one of the discrete grooves, thereby holding the load disc in place at the desired position in the spring recess and at the desired compression load on the fuel cells.

Load disc 34 and retaining ring 36 are preferably two separate parts. As the load disc is connected to the collar at its inner circumference and also is in contact with the retaining ring at its outer circumferential area, the load disc necessarily has a relatively large planar surface and sufficiently thick to apply and distribute a sufficient compressive force on the disc springs. However, it is difficult to design a load disc with a relatively large planar surface area to be resilient enough so that it can be deformed to fit into the spring recess and then released into one of the discrete grooves in the spring recess. As a result, a separate resilient retaining ring is employed to engage with one of the discrete grooves and the outer circumferential area of the load disc. This also allows the spring assembly and the load disc to be substantially physically separated from the inner axial surface of the spring recess so that the spring assembly and load disc can be more easily loaded into the spring recess during assembly. This also prevents the spring assembly and load disc from contacting the grooves on the inner axial surface of the spring recess, thereby preventing abrasion of the inner axial surface of the spring recess. Additionally, this also decouples the competing thickness requirement for each part. For example, using two separate parts allows for a thinner resilient retaining ring to improve the resolution of the preferred compression load and a thicker load disc to apply and distribute a sufficient compressive force on the disc springs. One skilled in the art will appreciate that the cross-sectional thickness of the load disc should be greater than the cross-sectional thickness of the retaining ring (and the cross-sectional thickness of the discrete groove) so that the load disc does not engage with the discrete groove should the load disc come into contact with the inner axial surface of the spring recess due to movement and/or misalignment.

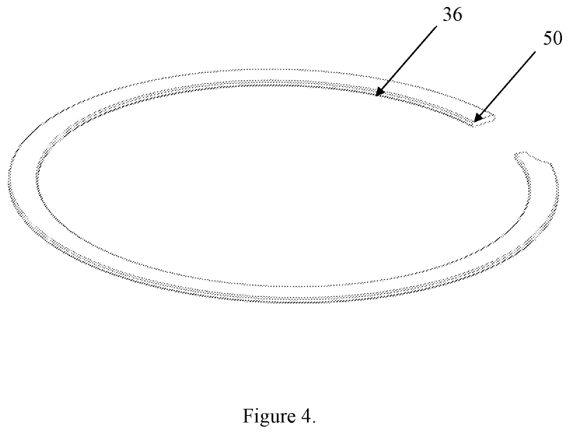

Retaining ring 36 can be made resilient in any manner known in the art. Preferably, retaining ring 36 is capable of deforming in the radial direction but substantially stiff in the axial direction. FIG. 4 shows an exemplary retaining ring with a gap 50 for allowing radial deformation. Any suitable material may be selected for the retaining ring, for example, metal such as high strength spring steel. Such retaining rings are typically available as off-the-shelf parts, thus making these rings cost-effective.

During assembly of the fuel cell stack, one skilled in the art will appreciate that the springs will be compressed in discrete steps that are equal to one groove pitch (i.e., the distance between each discrete groove). If a higher compression pressure is desired, then the load ring should be engaged with a groove that is in a lower position in the spring recess (i.e., closer to the second end plate). Conversely, if a lower compression pressure is desired, then the load ring should be engaged with a groove that is in a higher position in the spring recess (i.e., farther from the second end plate). One skilled in the art will appreciate that a thinner retaining ring and a smaller distance between each of the grooves will result in a higher resolution when determining the compression pressure exerted by the compression assembly on the fuel cells. A higher resolution is desirable so that the compression pressure exerted on the fuel cells can be more finely tuned.

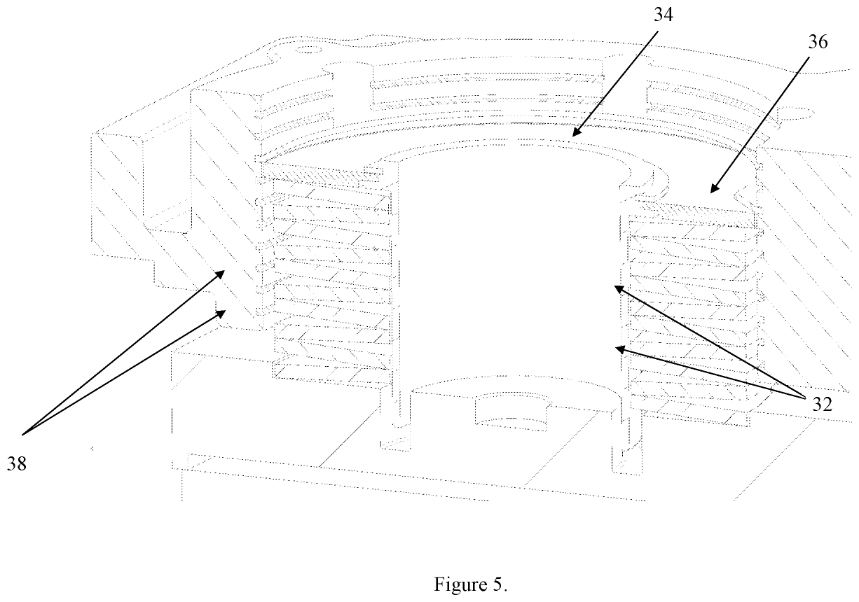

Depending on the desired compression pressure and the dimensions of resilient retaining ring 36, the inventors have discovered that resilient retaining ring 36 may tilt on an angle (or inversely cone) in the spring recess after assembly as shown in FIG. 5, thus increasing the risk of releasing itself out of the discrete groove and out of the compression assembly. However, simply making resilient retaining ring 36 thicker in cross-section to increase its stiffness to reduce tilting would decrease the compression pressure resolution, which is undesirable as described in the foregoing. It is also clear in FIG. 5 that load disc 34 and spring assembly 32 do not contact the inner axial surface of the spring recess.

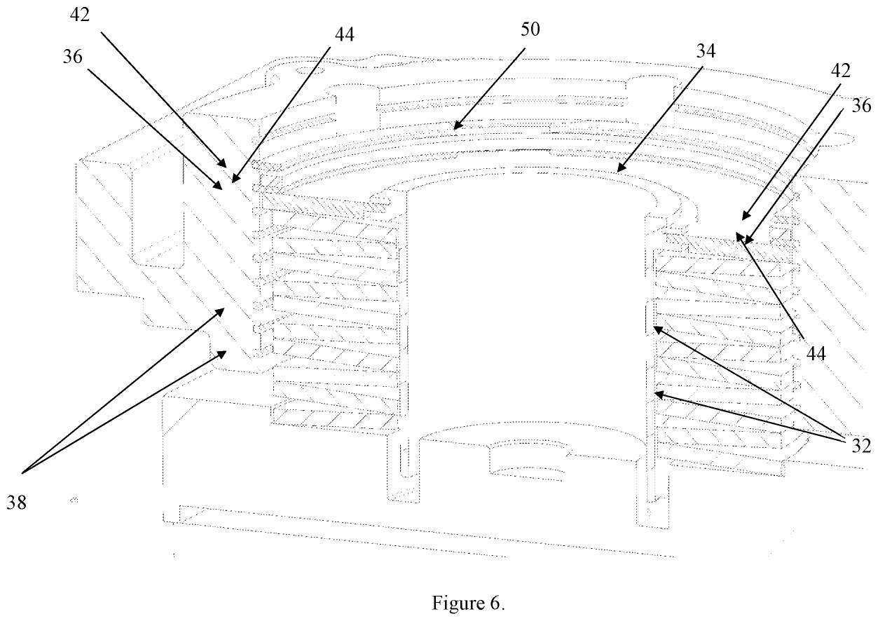

FIG. 6 shows another embodiment in which a second resilient retaining ring 42 and a spacer 44 are used in the spring recess. Second resilient retaining ring 40 is engaged in the next discrete groove adjacent to (i.e., above) the discrete groove with which first resilient retaining ring 36 is engaged. Spacer 44 is disposed between first resilient retaining ring 36 and second resilient retaining ring 42 and in contact therewith so that at least a portion of the axial compressive force from the compressed spring can be transferred from first resilient retaining ring 36 to second resilient retaining ring 40. One skilled in the art will appreciate that spacer 42 does not engage with any of the discrete grooves.

Without being bound by theory, the inventors have surprisingly discovered that not only did the additional second resilient retaining ring 40 and spacer 42 reduce tilt of first resilient retaining ring 36, but the axial compression load that could be sustained by the resilient retaining rings nearly doubled without tilting issues, thus significantly improving its safety. Furthermore, this additional retaining ring and spacer design is low cost as both the retaining ring and spacer are available as off-the-shelf parts.

One skilled in the art will readily be able to determine a suitable material for the resilient retaining rings and spacer. For example, the resilient retaining rings and spacer may be metal, such as aluminum. The materials for each of the resilient retaining rings and spacer may be the same or may be different. The spacer may also be any suitable shape and size so long as it can transfer load from the first resilient retaining ring to the second resilient retaining ring and does not interfere with the function of the compression assembly. In some embodiments, the spacer should have an outer diameter that is less than the diameter of the spring recess so that it is physically separated from the discrete grooves, a cross-sectional thickness that is about the distance between adjacent discrete grooves, and an inner diameter that is greater than the inner diameter of the resilient retaining ring when it is compressed in the radial direction during assembly as this will allow the simultaneous installation of the two resilient retaining rings and the spacer using the mechanical fingers as described in the foregoing.

In one method to assemble fuel cell stack 2 of FIG. 1, fuel cells 7 are stacked on top of a first current collector 44 and first end plate 4. A second current collector 46 is placed on top of fuel cells 7, and then compression plate 22 as well as compression housing 24 are placed on top of second current collector 46. Planar sides 14, 16, 18, 20 are attached to first end plate 4 and compression housing 24 via fasteners (not shown) that may be removed and re-attached, for example, when fuel cells and/or flow field plates in the fuel cell stack need to be replaced. Spring assembly 32 is placed in each spring recesses 30, a load disc 34 is placed on top of each spring assembly 32, and then the spring assemblies are compressed to the desired fuel cell stack compression pressure. A resilient retaining ring 36 is radially compressed, placed into spring recess 30 on top of load disc 34 at the desired position in the spring recess to exert the desired compressive force on load disc 34 and spring assembly 32, and then released so that its outer circumferential edge engages with one of discrete grooves 38. In this manner, the fuel cell stack remains a fixed length while second end plate 22 remains movable with compression and release of spring assembly 32 due to, for example, fuel cell operation and/or fuel cell component creep. If an additional retaining ring and spacer are employed, the load disc, the resilient retaining rings and the spacer may be simultaneously loaded into the spring recess in one step as described in the foregoing.

While the restraining mechanism has been shown to be in the form of an enclosure with sides, one skilled in the art will appreciate that the restraining mechanism may also be designed in other forms, for example, with compression straps and/or tie rods.

While the compression plate assembly has been described in the context of fuel cells with a polymer electrolyte, it is contemplated that the compression assembly may also be suitable for other types of fuel cells, such as phosphoric acid and solid oxide, and applications thereof, such as flow batteries and electrolyzers.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A fuel cell stack comprising a first end plate, a compression plate assembly, a plurality of fuel cells interposed between the first end plate and the compression plate assembly, and a restraining mechanism for substantially preventing movement of the first end plate from the compression plate assembly, wherein the compression plate assembly comprises:
a second end plate having a first planar surface and an opposing second planar surface, wherein the first planar surface is adjacent the fuel cell stack;
a compression housing adjacent the opposing second planar surface of the second end plate, wherein the compression housing comprises:
a spring recess comprising a plurality of discrete grooves on its inner axial surface;
a spring assembly in the spring recess and in contact with the second planar surface of the second end plate;
a load disc in the spring recess and in contact with the spring assembly; and
a resilient retaining apparatus in the spring recess and in contact with the load disc;
wherein
the resilient retaining apparatus engages with one of the plurality of discrete grooves and the load disc; and
the load disc and the spring assembly are physically separated from the inner axial surface of the spring recess.

2. The fuel cell stack of claim 1, wherein the spring assembly comprises a plurality of disc springs.

3. The fuel cell stack of claim 1, wherein a cross-sectional thickness of the load disc is greater than a cross-sectional thickness of the resilient retaining ring.

4. The fuel cell stack of claim 1, wherein the resilient retaining apparatus further comprises a first resilient retaining ring that engages with one of the plurality of discrete grooves and an outer circumferential area of the load disc.

5. The fuel cell stack of claim 4, wherein the resilient retaining apparatus further comprises a second resilient retaining ring that engages with an adjacent one of the plurality of discrete grooves, wherein the first and second resilient retaining rings are separated by a spacer and whereby at least some compressive force is transmitted from the first retaining ring to the second retaining ring through the spacer.

6. The fuel cell stack of claim 4, wherein the first resilient retaining ring comprises a notch.

7. The fuel cell stack of claim 4, wherein:
an outer diameter of the spacer is less than a diameter of the spring recess, and
an inner diameter of the spacer is greater than an outer diameter of the resilient retaining ring when it is compressed in the radial direction during assembly.

8. The fuel cell stack of claim 1, wherein the load disc further comprises an axial collar extending through the spring assembly.

9. The fuel cell stack of claim 8, wherein the housing further comprises a collar recess on a bottom planar surface of the housing for containing the axial collar.

10. The fuel cell stack of claim 1, wherein the restraining mechanism comprises at least one compression band that circumscribes the first end plate, the compression plate assembly, and the plurality of fuel cells interposed therebetween.

11. The fuel cell stack of claim 1, wherein the spring recess comprises a plurality of load grooves that extend in a parallel direction relative to an axial direction of the spring recess.

12. A method of assembling the fuel cell stack of claim 1, the method comprising:
providing the spring assembly into the spring recess;
providing the load disc into the spring recess on top of the spring assembly so that the load disc is in contact therewith;
compressing the load disc in an axial direction relative to the spring recess so that an axial compressive force is exerted on the spring assembly;
compressing a resilient retaining apparatus in a radial direction and providing the compressed resilient retaining apparatus on top of the load disc; and
releasing the compressed resilient retaining apparatus so that the resilient retaining apparatus engages with one of the plurality of discrete grooves and the load disc.

13. The method of claim 12, wherein the resilient retaining apparatus comprises a first resilient retaining ring that engages with one of the plurality of discrete grooves and an outer circumferential area of the load disc upon release of the compressed first resilient retaining ring.

14. The method of claim 13, wherein the resilient retaining apparatus further comprises a second resilient retaining ring and a spacer, wherein the first and second resilient retaining rings are separated by a spacer, the method further comprising the steps of:
stacking the first and second resilient retaining rings so that the first and second resilient retaining rings are separated by the spacer;
compressing the stacked first and second resilient retaining rings in a radial direction with the spacer therebetween;
providing the compressed first and second resilient retaining rings with the spacer therebetween on top of load disc; and
releasing the compressed first and second resilient retaining rings so that the second resilient retaining ring engages with an adjacent one of the plurality of discrete grooves, whereby at least some load compressive force is transmitted from the first retaining ring to the second retaining ring through the spacer upon release of the compressed first and second resilient retaining ring.
